(19) United States
(12) Patent Application Publication
(10) Pub. No.: US 2007/0127048 A1
(43) Pub. Date: Jun. 7, 2007

(54) Printing apparatus, printing method and recording medium

(75) Inventor: Eiji Minami, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/634,400

(22) Filed: Dec. 5, 2006

(30) Foreign Application Priority Data
Dec. 5, 2005 (JP) 2005-350236
Nov. 2, 2006 (JP) 2006-298562
Nov. 30, 2006 (JP) 2006-323824

(51) Int. Cl. G06K 15/00

(52) U.S. Cl. 358/1.12

(57) ABSTRACT

A medium information acquirer is operable to acquire first medium information indicative of first contents stored in a recording medium. A label information generator is operable to generate, based on the first medium information, a first label information indicative of a first label which is to be printed on the recording medium. A printing section is operable to print the first label on the recording medium based on the first label information.

The disclosures of Japanese Patent Application Nos. 2005-350236 filed on Dec. 5, 2005, 2006-298562 filed on Nov. 2, 2006, and 2006-323824 filed on Nov. 30, 2006 including specifications, drawings and claims are incorporated herein by reference in their entirety.

### BACKGROUND

The present invention relates to a printing apparatus, a printing method, a printing program, and a recording medium which can print image, characters, figures, and the like on a surface of a recording medium.

In the past, for example, a personal computer or the like could be allowed to store contents such as digital images photographed by a digital camera or the like in a recording medium such as a compact disc (CD) and a digital versatile disc (DVD). In such a recording medium, it is difficult to see which contents are stored in the recording medium. For this reason, in order to confirm which recording medium stores desired contents among a plurality of recording media, a complex operation requiring labor and time must be performed.

Therefore, for example, there was suggested a printing apparatus which can a label generated by an image editor such as a personal computer on the surface of a recording medium (see Japanese Patent Publication No. 2005-71566A). By printing labels including medium information indicating contents stored in the recording medium on the surfaces of the recording medium by the use of such a printing apparatus, a user can confirm which recording medium stores which contents from the labels printed on the surfaces of the recording medium.

However, in the above-mentioned technology, there was a problem in that the labor and time is required for generating a label containing medium information indicating contents stored in a recording medium by the use of the image editor such as a personal computer.

### SUMMARY

It is therefore an advantage of some aspects of invention to provide a printing apparatus, a printing method and a recording medium, which can print a label indicative of contents stored in a recording medium on a surface of the recording medium.

In order to achieve the above described advantage, according to the aspect of the invention, there is provided a printing apparatus comprising:

a medium information acquirer, operable to acquire first medium information indicative of first contents stored in a recording medium;

a label information generator, operable to generate, based on the first medium information, a first label information indicative of a first label which is to be printed on the recording medium; and

a printing section, operable to print the first label on the recording medium based on the first label information.

With this configuration, it is possible to acquire the first medium information indicative of the first contents stored in the recording medium and to print a first label corresponding to the acquired first medium information on the surface of the recording medium. Accordingly, a user can easily generate the first label corresponding to the first medium information indicative of the first contents stored in the recording medium and print the generated first label on the surface of the recording medium without performing a process of generating a label using an image editor such as a personal computer requiring labor and time. The user can easily know which contents are stored in the recording medium, by reference to the first label printed on the surface of the recording medium.

The printing apparatus may further comprise a judge, operable to judge whether a second label corresponding to second medium information indicative of second contents of the recording medium has been printed on the recording medium. The label information generator may be operable to generate second label information indicative of the second label in a case where the judge judges that the second label has not been printed on the recording medium.

With this configuration, when the second contents are added to the recording medium, a user can easily generate the second label corresponding to the second medium information indicating the second contents added to the recording medium and print the generated second label on the surface of the recording medium. The user can easily know which contents are added to the recording medium, by reference to the first label and the second label printed on the surface of the recording medium.

The printing section may be operable to print the second label on the recording medium in a position where the first label is not printed, based on the second label information.

With this configuration, the user can easily know which contents are added to the recording medium, by reference to the second label printed on the surface of the recording medium in a position where the first label is not printed.

The second medium information may include print status information indicating whether the second label has been printed on the recording medium. The judge may judge whether the second label is printed on the recording medium based on the print status information.

With this configuration, it is possible to easily judge whether the second label corresponding to the second medium information is printed already on the surface of the recording medium without performing a user's work requiring labor and time such as setting information of the label printed on the surface of the recording medium, scanning the surface of the recording medium by a scanner, or acquiring data other than the medium information.

The printing apparatus may further comprise:

an updater, operable to update the print status information.

With this configuration, the print status information can be updated in order to avoid printing the second label corresponding to the second medium information, indicative of the added second contents, which has been printed on the surface of the recording medium already.

The printing section may be operable to print alignment information on the recording medium in a case where the recording medium is disk-shaped. The alignment information may be adapted to be referred in order to determine a position on the recording medium to which the first label is printed.

With this configuration, it is possible to always set the disc-shaped recording medium in the printing apparatus along a predetermined circumferential direction, for example, by placing the recording medium on a tray of the printing apparatus such that the alignment information opposes positioning information which is printed in the printing apparatus.

The printing apparatus may further comprise:

a calculator, operable to calculate amount information indicative of at least one of an used space amount and a free space amount in the recording medium. The label information generator may be operable to generate the first label information based on the amount information.

With this configuration, it is easily possible to know the used space amount or a free space amount in the recording medium by reference to the first label information generated based on the amount information.

The printing apparatus may further comprise:

a judge, operable to judge whether the recording medium is rewritable. The label information generator may be operable to generate the first label information so as to indicate whether the recording medium is rewritable.

With this configuration, it is easily possible to know whether the recording medium is rewritable by reference to the first label information.

The label information generator may be operable to generate the first label information so as to include a character or a symbol indicating that the recording medium is not rewritable.

The label information generator may generate the first label information so as to include a graph indicative of the amount information.

The printing apparatus may further comprise:

a judge, operable to judge whether the recording medium is rewritable. The label information generator may be operable to generate the first label information such that the graph indicates that there is no free space in the recording medium in a case where the judge judges that the recording medium is not rewritable irrespective of the amount information.

The medium information may be operable to read meta-data stored in the recording medium to acquire the first medium information.

With this configuration, for example, when a plurality of printing apparatuses are provided, all the printing apparatuses need not store the first medium information indicating the first contents stored in the recording medium. Therefore, the printing apparatuses can acquire the first medium information by the common method of reading out the meta-data stored in the recording medium along with the first contents, without performing the setting of an acquisition source of the medium information or the changing of a printing process program with the setting of the acquisition source of the recording medium, requiring labor and time.

According to the aspect of the invention, there is also provided a printing method, comprising:

acquiring medium information indicative of contents stored in a recording medium;

generating label information indicative of a label which is to be printed on the recording medium, based on the medium information; and

printing the label on the recording medium based on the label information.

According to the aspect of the invention, there is also provided a storage medium storing a program causing a printer or a computer to execute the above-described method.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram schematically illustrating an example of a printing operation of a printing apparatus;

FIG. 2 is a block diagram illustrating an example of a functional structure of the printing apparatus;

FIG. 3 is a block diagram illustrating an example of a hardware structure of the printing apparatus;

FIG. 4 is a flowchart illustrating an exemplary procedure of the printing operation;

FIG. 5 is a diagram illustrating an example of a structure of data stored in a disc;

FIG. 6 is a diagram illustrating exemplary values of medium information stored in a disc;

FIG. 7 is a diagram illustrating an example of a label printed on a surface of a disc;

FIG. 8 is a diagram illustrating an exemplary structure of data stored in a disc;

FIG. 9 is a diagram illustrating exemplary values of medium information stored in a disc;

FIG. 10 is a diagram illustrating an example of a label printed on a surface of a disc;

FIG. 11 is a diagram illustrating an example of a method of setting a disc into a label printer;

FIG. 12 is a diagram illustrating an example of a method of setting a disc into a label printer; and

FIG. 13 is a diagram illustrating an example of a label which indicates whether a disc is rewritable or not.

### DETAILED DESCRIPTION OF THE EMBODIMENTS

Hereinafter, a printing apparatus according to an embodiment of the present invention will be described in detail with reference to the attached drawings.

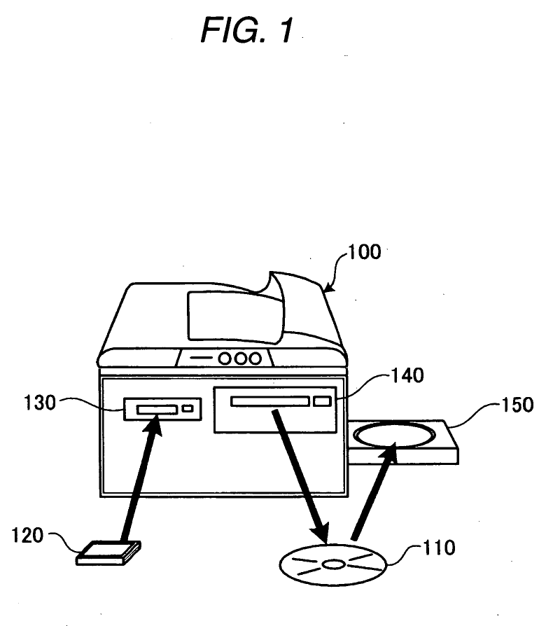

As shown in FIG. 1, the printing apparatus 100 according to the embodiment includes a memory card reader 130, a disc driver 140, and a label printer 150.

The memory card reader 130 can input the contents 112 such as image data, music data, and moving picture data stored in a memory card 120 to the printing apparatus 100 by inserting the memory card 120 such as a Compact Flash®, a smart medium, an SD memory card, a multimedia card, a memory stick, and a USB flash memory into the memory card reader.

The disc drive 140 can record the contents 112 acquired from the memory card 120 on a CD/DVD disc 110 by inserting the CD/DVD disc such as a CD-R, a CD-RW, a DVD-R, and a DVD-RW into the disc drive. The label printer 150 can print a label including desired images, characters, and figures on the surface of the CD/DVD disc 110, by inserting the CD/DVD disc 110 into the label printer

The printing apparatus 100 according to this embodiment can record medium information 111 on the CD/DVD disc 110 along with the contents 112, when recording the contents 112 on the CD/DVD disc 110. The medium information includes information on the disc (hereinafter, referred to as “disc information”) and information on one or plural albums (hereinafter, referred to as “album information”). In this embodiment, the disc information and the album information include “ID information”, “title information”, “drafter information”, “drafting date information”, “size information”, and “label printing status information.”

An ID for identifying a disc and an album at a glance is set as the “ID information.” A title of the disc and the album is set as the “title information.” A drafter of the disc and the album id set as the “drafter information.” The drafting date of the disc and the album is set as the “drafting date information.” A data size stored in the disc and the album is set as the “size information.” Information indicating whether the disc information and the album information corresponding to the disc and the album are printed already on the surface of the CD/DVD disc 110 is set as the “label printing status information.”

By inserting the CD/DVD disc 110 into the label printer 150, it is possible to print the label indicating the medium information 111 read out from the CD/DVD disc 110 on the surface of the CD/DVD disc 110.

In this way, the printing apparatus according to this embodiment can record the medium information 111 on the CD/DVD disc 110 along with the contents 112. In addition, the printing apparatus 110 can print the label indicating the medium information 111 acquired from the CD/DVD disc 110 on the surface of the CD/DVD disc 110. Accordingly, a user can print the label indicating contents of data stored in the CD/DVD disc 110 on the surface of the CD/DVD disc 110, without performing a complex operation requiring labor and time. The user can know the contents of the data stored in the CD/DVD disc 110 by the use of the label printed on the CD/DVD disc 110.

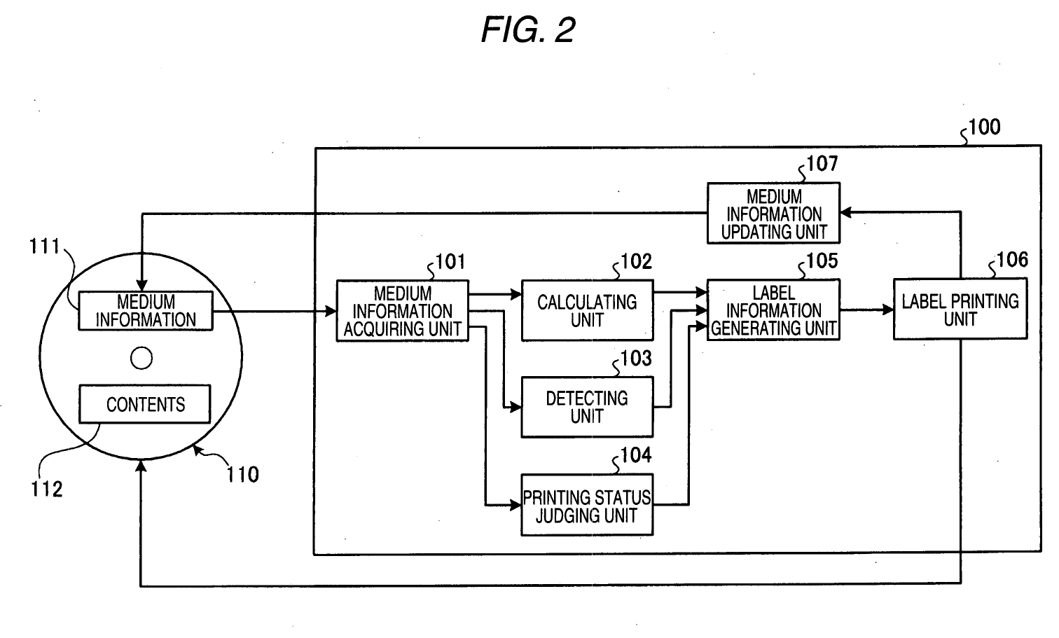

As shown in FIG. 2, the printing apparatus 100 according to this embodiment includes a medium information acquiring unit 101, a calculating unit 102, a detecting unit 103, a printing status judging unit 104, a label information generating unit 105, a label printing unit 106, and a medium information updating unit 107.

The medium information acquiring unit 101 acquires the medium information 111 from the CD/DVD disc 110. The calculating unit 102 calculates a disc capacity (used space amount and a free space amount) in the CD/DVD disc 110. For example, the calculating unit 102 calculates the disc capacity in the CD/DVD disc 110 on the basis of the medium information 111 acquired by the medium information acquiring unit 101.

The detecting unit 103 detects whether the CD/DVD disc 110 is rewritable or not. For example, the detecting unit 103 detects that the CD/DVD disc 110 is not rewritable based on the disc capacity calculated by the calculating unit 102 in a case that the free space amount of the CD/DVD disc 110 is lower than a predetermined amount. The detecting unit 103 also detects that the CD/DVD disc 110 is not rewritable in a case that the CD/DVD disc 110 is closed or finalized and that a number of folders, a number of files, a number of backup folders, and a number of sessions or the like are greater than a predetermined number.

The printing status judging unit 104 judges whether the disc information and the album information have been already printed on the surface of the CD/DVD disc 110 on the basis of the “label printing status information” included in the medium information 111 acquired by the medium information acquiring unit 101.

The label information generating unit 105 generates information with respect to a label (hereinafter, referred to as “label information”) to be printed on the surface of the CD/DVD disc 110, on the basis of the medium information 111 acquired from the CD/DVD disc 110 by the medium information acquiring unit 101, information with respect to a result which is calculated by the calculating unit 102, and information with respect to a result which is detected by the detecting unit 103.

The label printing unit 106 prints a label on the surface of the CD/DVD disc 110 on the basis of the label information generated by the label information generating unit 105. The label printing unit 106 also prints positioning information on the surface of the CD/DVD disc 110. The medium information updating unit 107 updates the medium information 111 stored in the CD/DVD disc 110. For example, the medium information updating unit 107 updates the “label printing status information” included in the medium information 111.

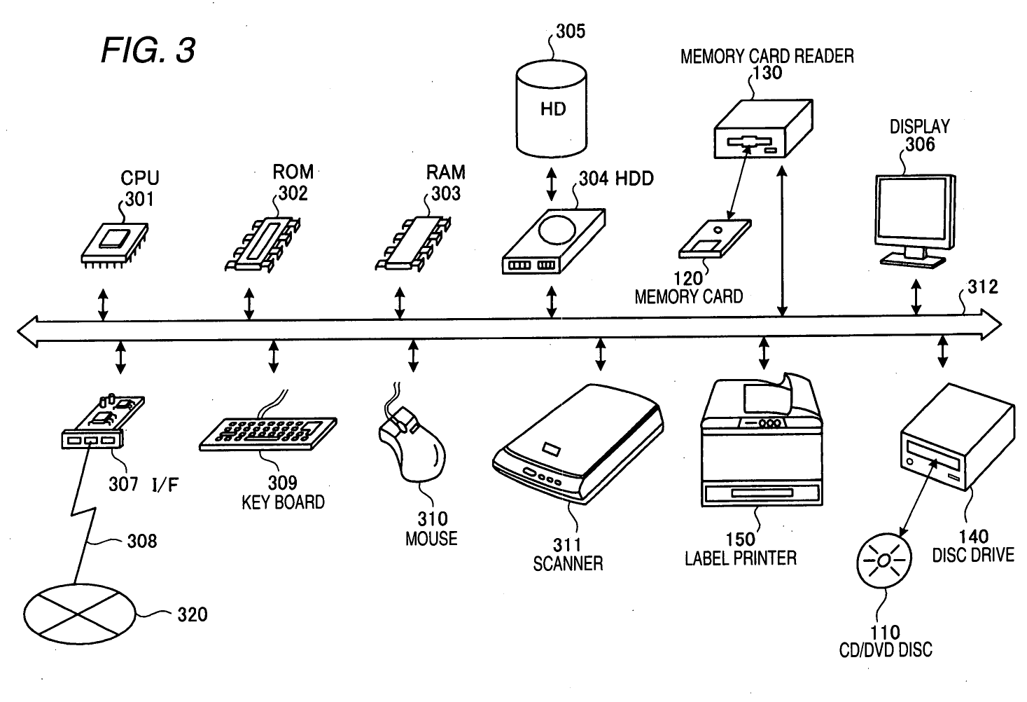

FIG. 3 is a block diagram illustrating an example of a hardware configuration of the printing apparatus according to this embodiment. In the following description, the same elements as described above are denoted by the same reference numerals and description thereof will be omitted. The printing apparatus 100 according to this embodiment includes a central processing unit (CPU) 301, a read only memory (ROM) 302, a random access memory (RAM) 303, a hard disc drive (HDD) 304, a hard disc (HD) 305, a memory card reader 130, a memory card 120, a display 306, an interface (I/F) 307, a communication cable 308, a key board 309, a mouse 310, a scanner 311, a label printer 150, a disc drive 140, and a CD/DVD disc 110, and these elements are connected to each other through a bus 312.

The CPU 301 controls the entire printing apparatus 100 by performing predetermined operating processes. The ROM 302 stores a variety of control programs. Data stored in the ROM 302 can be rewritten by a user's operation, but is not erased by turning off the power supply. The RAM 303 stores variable data so as to be freely rewritten and serves as a work area of the CPU 301. The RAM 303 may be a volatile memory of which the written data are erased by turning off the power supply or may be a non-volatile memory which is backed up by a battery, etc.

The HDD 304 controls the reading and writing of data from and to the HD 305 in accordance with a control command of the CPU 301. The HD 305 stores a variety of control programs or a variety of data so as to be readable by the CPU 301. The HD 305 permits the writing of data by the HDD 304 and stores the written data in a non-volatile manner. The memory card reader 130 controls the reading and writing of data from and to the memory card 120 in accordance with the control command of the CPU 301.

The memory card 120 stores a variety of control programs or a variety of data so as to be readable by the CPU 301. The memory card 120 is a detachable recording medium permitting the writing of information by the memory card reader 130 and storing the written data in a non-volatile manner. A Compact Flash, a smart medium, an SD memory card, a multimedia card, a memory stick, a USB flash memory, and the like can be used as the memory card 120.

The display 306 is composed of a display device such as a CRT (Cathode Ray Tube), a TFT (Thin Film Transistor) liquid crystal display device, an organic EL (Electroluminescence) display device, or a plasma display device. A variety of information such as icons, a cursor, menus, windows, characters, and figures are displayed on the display 306.

The I/F 307 is connected to a network 320 such as a LAN (Local Area Network) or a WAN (Wide Area Network) through a communication cable 308, serves as an interface between the network 320 and the printing apparatus 100, and controls the input and output of data to and from the printing apparatus 100.

The key board 309 includes keys for inputting characters, numerals, and a variety of instructions and inputs data. The key board may be an input pad such as a touch panel or a ten key. The mouse 310 performs movement or range selection of the cursor or movement or size change of the windows. A track ball or a joy stick may be used if it has the function of a pointing device.

The scanner 311 optically reads out an image printed on a sheet of paper and inputs the image data to the printing apparatus 100. The label printer 150 prints a label including images, characters, and figures on the surface of the CD/DVD disc 110. A laser printer or an inkjet printer can be used as the label printer 150. The disc drive 140 controls the reading and writing of data from and to the CD/DVD disc 110 in accordance with a control command from the CPU 301.

The CD/DVD disc 110 stores a variety of control programs or a variety of data so as to be readable by the CPU 301. The CD/DVD disc 110 is a detachable recording medium permitting the writing of information by the disc drive 140 and stores the written data in a non-volatile manner. The CD/DVD disc 110 stores the contents 112 such as image data, music data, and moving picture data. The CD/DVD disc 110 stores the medium information 111 such as disc information and album information.

In the functional configurations of the printing apparatus 100 according to this embodiment, the medium information acquiring unit 101 and the medium information updating unit 107 are embodied by the CPUT 301 and the disc drive 140, the label information generating unit 105 and the printing status judging unit 104 are embodied by the CPU 301, and the label printing unit 106 is embodied by the label printer 150.

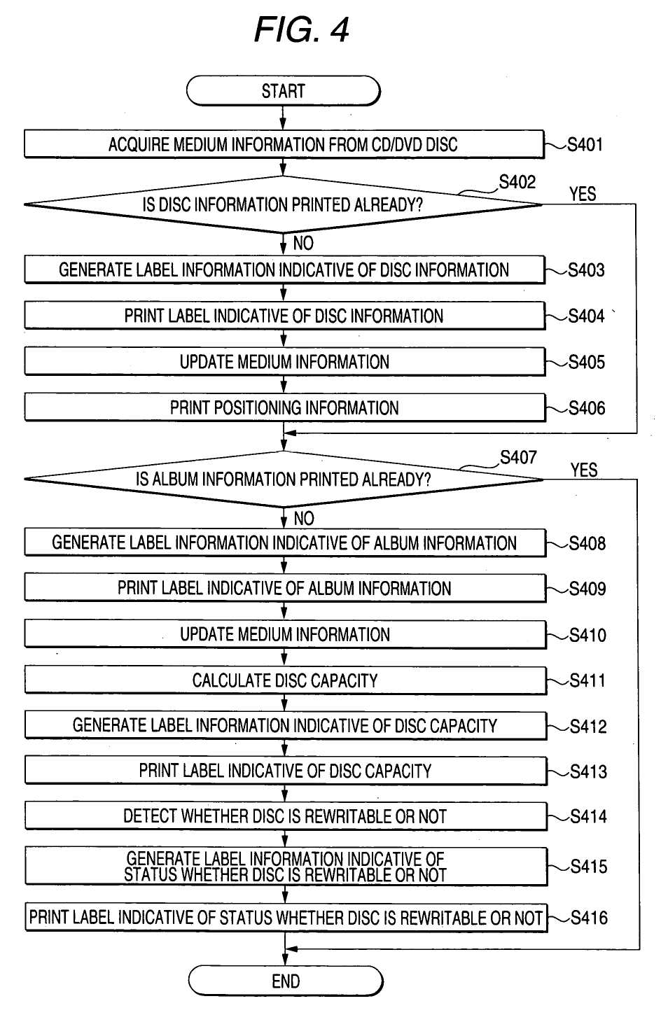

Hereinafter, the printing procedure according to this embodiment will be described with reference to FIG. 4.

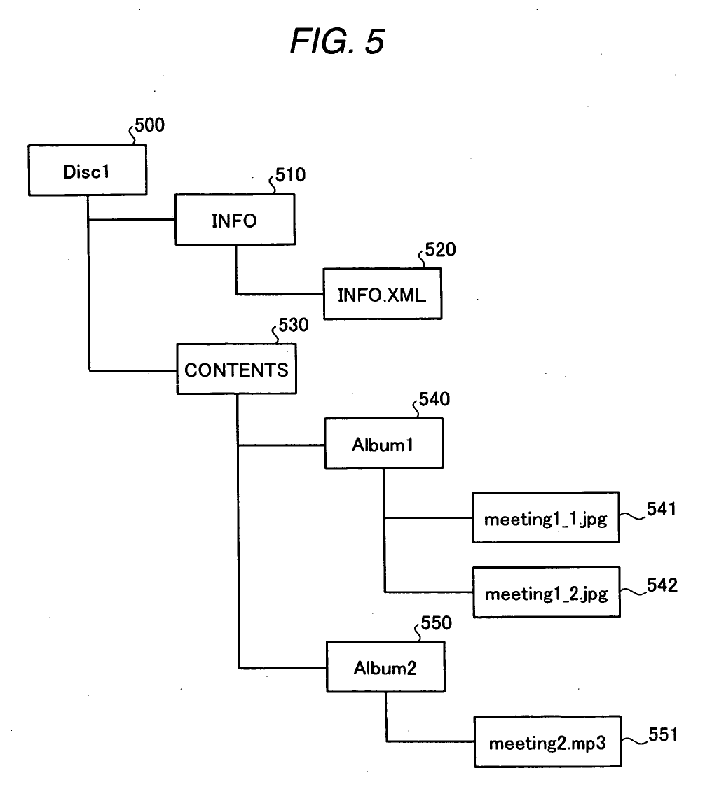

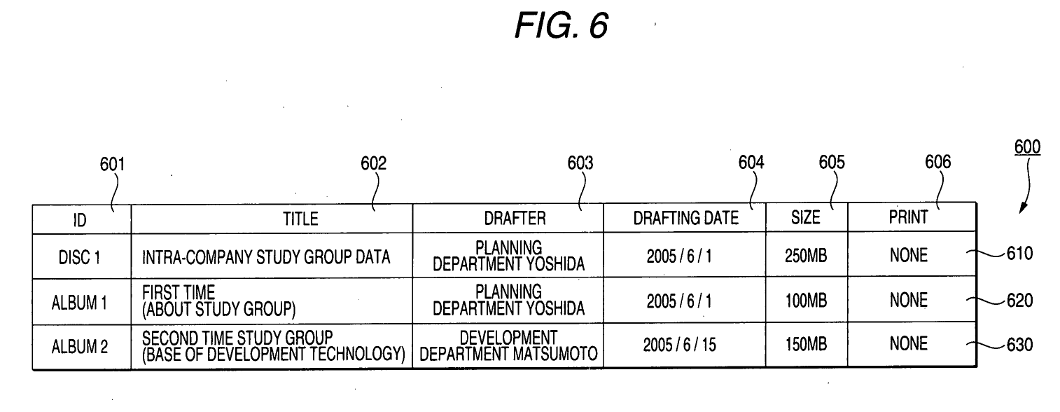

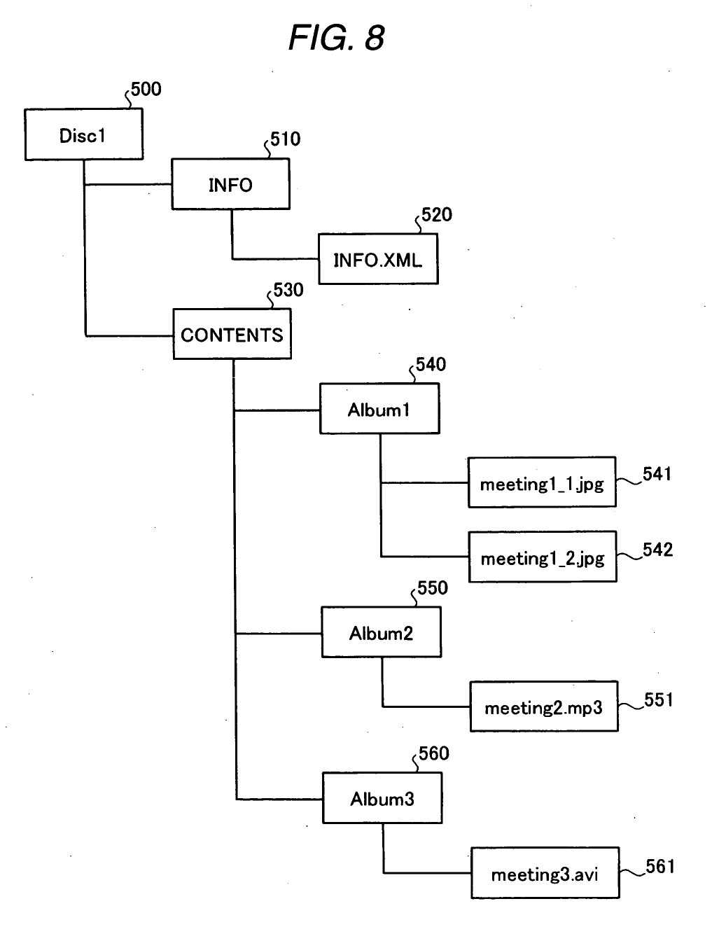

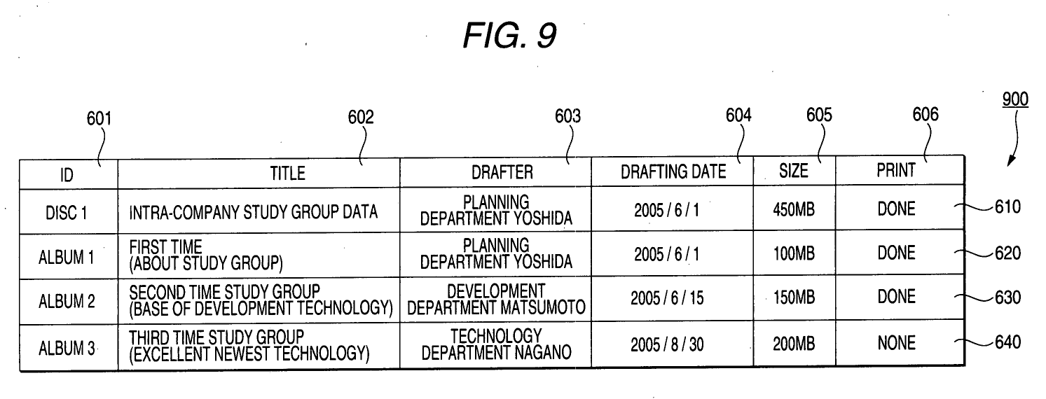

First, the medium information acquiring unit 101 acquires the medium information 111 from the CD/DVD disc 110 (step S401). An example of a data structure stored in the CD/DVD disc 110 will be described later with reference to FIG. 5 and an example of the medium information 111 stored in the CD/DVD disc 110 will be described later with reference to FIG. 6. An example of a data structure stored in the CD/DVD disc 110 to which the contents 112 are added will be described later with reference to FIG. 8 and exemplary values of the medium information 111 stored in the CD/DVD disc 110 to which the contents 112 are added will be described later with reference to FIG. 9.

Next, the printing status judging unit 104 judges whether disc information corresponding to the CD/DVD disc 110 is printed already on the surface of the CD/DVD disc 110 (step S402), on the basis of the medium information 111 acquired in the step S401. The printing status judging unit 104 performs the judgment on the basis of the values set as the “label printing status information” of the disc information included in the medium information 111 acquired in step S401. For example, when “none” is set as the “label printing status judging information”, the printing status judging unit 104 judges that the disc information is not printed. For example, when “done” is set as the “label printing status information”, the printing status judging unit 104 judges that the disc information is printed already.

When it is judged in step S402 that the disc information corresponding to the CD/DVD disc 110 is printed already (step S402: YES), steps S403 to S406 are skipped and step S407 is performed. When it is judged in step S402 that the disc information corresponding to the CD/DVD disc 110 is not printed (step S402: NO), step S403 is performed.

Next, the label information generating unit 105 generates label information including the disc information to be printed on the surface the CD/DVD disc 110 (step S403). The label information generating unit 105 generates the “title information”, the “drafter information”, and the “drafting date information” as the disc information to be printed on the surface of the CD/DVD disc 110. The label information generating unit 105 generates a string, in which a definite text “Disc Title:” and a string set as the “title information” included in the medium information 111 acquired in step S401 are combined, as the “title information.”

The label information generating unit 105 generates as the “drafter information a string in which a definite text “Creator:” and a string set as the “drafter information” of the disc information included in the medium information 111 acquired in step S401 are combined. The label information generating unit 105 generates as the “drafting date information” a string in which a definite text “Date:” and a string set as the “drafting date information” of the disc information included in the medium information 111 acquired in step S401 are combined.

Next, the label printing unit 106 prints the label including the disc information at a predetermined position on the surface of the CD/DVD disc 110 by the use of the label printer 150, on the basis of the label information including the disc information generates in step S403 (step 404).

Next, the medium information updating unit 107 updates the “label printing status information” of the disc information included in the medium information 111 stored in the CD/DVD disc 110 (step S405). The medium information updating unit 107 updates the “label printing status information” from the previously set “none” to the “done.”

Next, the label printing unit 106 prints positioning information on the circumference on the surface of the CD/DVD disc 110 by the use of the label printer 150 (S406).

Next, the printing status judging unit 104 judges whether the album information corresponding to all the albums included in the CD/DVD disc 110 is already printed on the surface of the CD/DVD disc 110 (step S407). The printing status judging unit 104 performs the judgment on the basis of the values included in the medium information 111 acquired in step S401 and set as the “label printing status information” of the album information corresponding to al the albums. For example, when “none” is set as any one of the “label printing status information”, the printing status judging unit 104 judges that the album information corresponding to all the albums is not printed. For example, when “done” is set as all the “label printing status information”, the printing status judging unit 104 judges that the album information corresponding to all the albums is already printed.

When it is judged in step S407) that the album information corresponding to all the albums included in the CD/DVD disc 110 is already printed on the surface of the CD/DVD disc 110 (step S407: YES), steps S408 to S412 are skipped and the series of steps are ended. When it is judged in step S407 that the album information corresponding to all the albums included in the CD/DVD disc 110 is not printed on the surface of the CD/DVD disc 110 (step S407: NO), step S408 is performed.

Next, the label information generating unit 105 generates label information including the album information to be printed on the surface of the CD/DVD disc 110 (step S408). The label information generating unit 105 generates the label information using the album information in which “none” indicating that the “label printing status information” is not printed is set among the album information corresponding to all the albums included in the medium information 111 acquired in step S401.

The label information generating unit 105 generates the “title information” and the “drafting date information” as the album information to be printed on the surface of the CD/DVD disc 110. The label information generating unit 105 uses the string set as the “title information” of the disc information included in the medium information acquired in step S401 as the “title information” to be generated. The label information generating unit 105 uses the string set as the “drafting date information” of the disc information included in the medium information 111 acquired in step S401 as the “drafting date information” to be generated. The label information generating unit 105 generates the label information including a plurality of album information by changing the row for each album information when a plurality of album information is included in the label information.

Next, the label printing unit 106 prints the label containing the album information as a predetermined position on the surface the CD/DVD disc 110 by the use of the label printer 150 on the basis of the label information including the album information generated in step S408. The label printing unit 106 prints the label at a position subsequent to the label including the album information printed already when the label including the album information is printed already.

Next, the medium information updating unit 107 updates the “label printing status information” of the album information corresponding to the album information printed in step S409 among the album information included in the medium information 111 stored in the CD/DVD disc 110 (step S410). The medium information updating unit 107 updates the “label printing status information” from the already set “none” to “done.”

Next, the calculating unit 102 calculates the disc capacity in the CD/DVD disc 110 (step S411). For example, the calculating unit 102 calculates the disc capacity in the CD/DVD disc 110 on the basis of a setting value of the “size information” included in the disc information, and a setting value of the “size information” included in the album information.

Next, the label information generating unit 105 generates including capacity information to be printed on the surface of the CD/DVD disc 110 (step S412). For example, the label information generating unit 105 generates graph data indicative of the disc capacity in the CD/DVD disc 110.

Next, the label printing unit 106 prints the label including the capacity information at a predetermined position on the surface of the CD/DVD disc 110 by the use of the label printer 150 on the basis of the label information including the capacity information generated in step S412 (step S413). For example, the label printing unit 106 prints a graph indicative of the disc capacity in the CD/DVD disc 110 on the surface of the CD/DVD disc 110 at a predetermined position.

Next, the detecting unit 103 detects, on the basis of the medium information 111 acquired in step S401, whether the CD/DVD disc 110 is rewritable or not (step S414). The label information generating unit 105 generates label information indicative of a state whether the CD/DVD disc 110 is rewritable or not, which is detected in step S414 (step S415). The label printing unit 106 prints, on the basis of the label information generated in step S415, a label indicative of the state whether the CD/DVD disc 110 is rewritable or not, via the label printer 150, on the surface of the CD/DVD disc 110 at a predetermined position (step S416). Finally, the procedure is terminated.

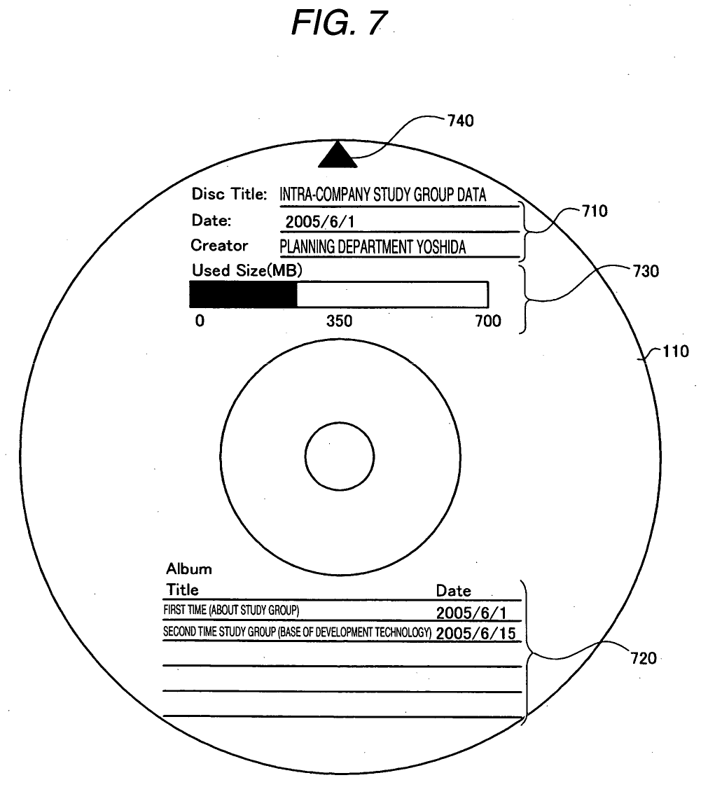

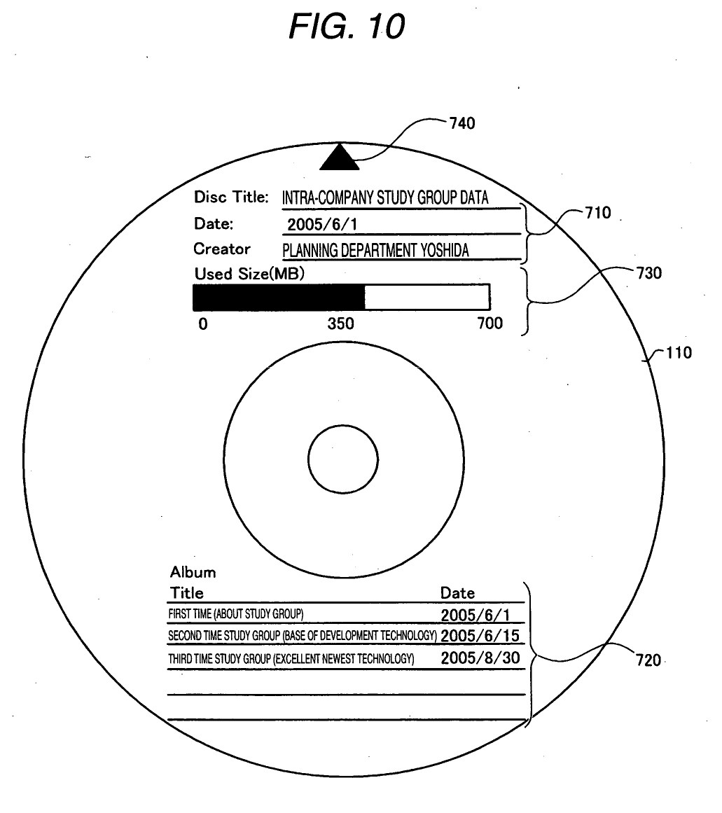

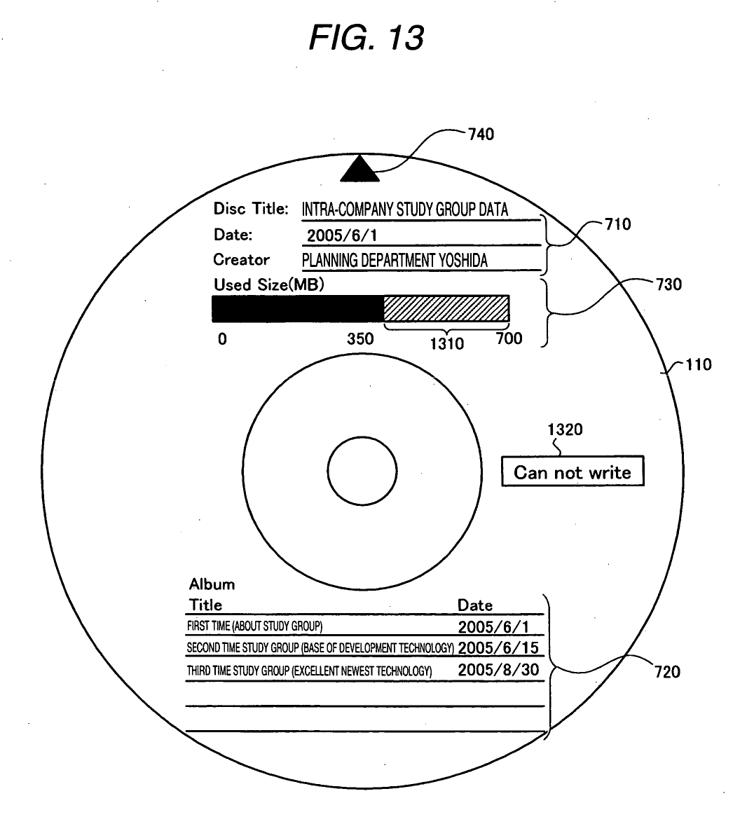

An example of the label printed on the surface of the CD/DVD disc 110 by the above-described procedure will be described later with reference to FIG. 7. An example of the label printed on the surface of the CD/DVD disc 110 after the contents 112 are added will be described later with reference to FIG. 10. An example of the label indicative of the state whether the CD/DVD disc 110 is rewritable or not will be described later with reference to FIG. 13.

As described above, according to this embodiment, it is possible to print a label containing new album information at a position subsequent to the label containing the album information already printed by the use of the label printer 150. It is possible to print the label containing the new capacity information at a position overlapping with the label containing the capacity information already printed. In this way, in order to print a label at a predetermined position, the CD/DVD disc 110 must be set to the label printer 150 along a predetermined circumferential direction.

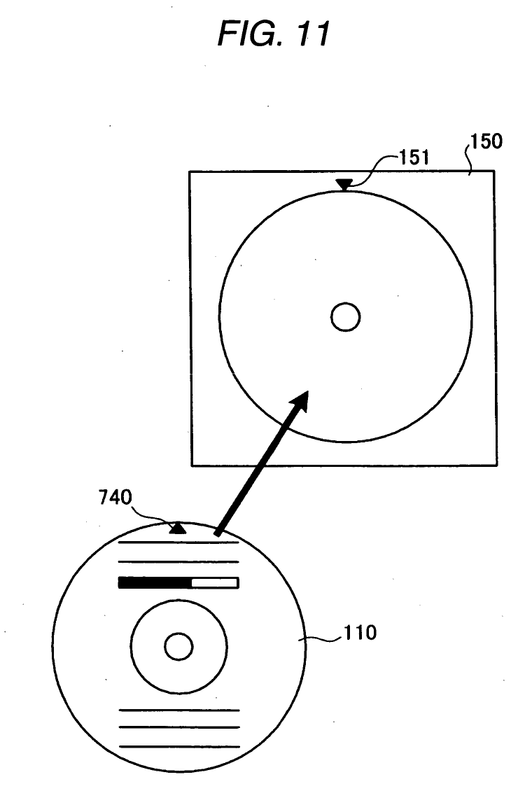

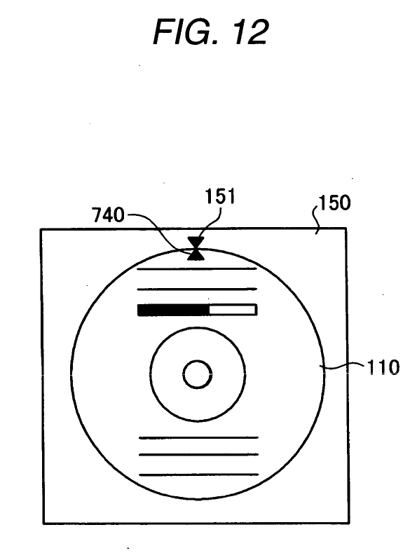

Accordingly, in this embodiment, it is possible to always set the CD/DVD disc 110 to the label printer 150 along a predetermined circumferential direction by matching the positioning information printed on the circumference of the surface of the CD/DVD disc 110 with a predetermined position of the label printer 150. An example of a method of setting the CD/DVD disc 110 to the label printer 150 will be described with reference to FIGS. 11 and 12.

FIG. 5 is a diagram illustrating an example of a data structure stored in the CD/DVD disc 110. As shown in FIG. 5, the CD/DVD disc 110 has a layered structure in which a directory 500 is the highest layer. The directory 500 has the same name “Disc1” as the disc ID as a directory name. The directory 500 includes a directory 510 and a directory 530.

The directory 510 has a directory name “INFO.” A file 520 is stored in the directory 510. The file 520 is a meta data having a file name “INFO.XML”, in which the medium information 111, etc. is described in the format of XML. The directory 530 has a directory name “CONTENTS.” The contents 112 such as image data, music data, and moving picture data are stored in the directory 530. An album 540 and an album 550 are stored in the directory 530.

The album 540 has an album ID “Album1.” Image data 541 and image data 542 are stored in the album 540. The image data 541 and the image data 542 are image data compressed in the format of JPEG and have file names “meeting1_{—}1.jpg” and “meeting1_{—}2.jpg”, respectively. The album 550 has the album ID “Album2.” Music data 551 are stored in the album 550. The music data 551 are music data compressed in the format of MP3 and has a file name “meeting2.mp3.”

FIG. 6 is a diagram illustrating exemplary values of the medium information 111 stored in the CD/DVD disc 110. As shown in FIG. 6, a table 600 shows the medium information 111 stored in the CD/DVD disc 110 in the format of table. The table 600 includes an ID 601, a title 602, a drafter 603, a drafting date 604, a size 605, and a label printing status 606.

An ID for identifying a disc and an album at a glance as the “ID information” is set to the ID 601. A title of the disc and the album as the “title information” is set to the title 602. A drafter of the disc and the album as the “drafter information” is set to the drafter 603. A drafting date of the disc and the album as the “drafting date information” is set to the drafting date 604. The size of data stored in the disc and the album as the “size information” is set to the size 605. Information indicating whether the disc information and the album information corresponding to the disc and the album are printed already on the surface of the CD/DVD disc 110 as the “label printing status information” is set to the label printing status 606.

The table 600 includes a row 610, a row 620, and a row 630. The row 610 includes the disc information corresponding to the CD/DVD disc 110 and the row 620 includes the album 540 described above with reference to FIG. 5. The row 630 is the album information corresponding to the album 550 described above with reference to FIG. 5.

For example, the medium information acquiring unit 101 acquires “Disc1” as the “ID information” of the disc information, “intra-company study group” as the “title information”, “planning department Yoshida” as the “drafter information”, “2005 Jun. 1” as the “drafting date information”, “250 MB” as the “size information”, and “none” as the “label printing status information.”

For example, the medium information acquiring unit 101 acquires “second study group (base of development technology)” as the “title information” of the album information corresponding to the album having the album ID of “Album2”, “development department Matsumoto” as the “drafter information”, “2005 Jun. 15” as the “drafting date information”, “150 MB” as the “size information”, and “none” as the “label printing status information.”

The data of the CD/DVD disc 110 described above with reference to FIG. 5 and the data of the medium information 111 described above with reference to FIG. 6 have structures in accordance with standard formats determined between a plurality of apparatuses regardless of types and makers of apparatuses including the printing apparatus 100. Accordingly, the medium information 111 stored in the CD/DVD disc 110 by the apparatuses such as a digital camera other than the printing apparatus 100 can be read out by the printing apparatus 100. The medium information 111 stored in the CD/DVD disc 110 by the printing apparatus 100 can be read out by the apparatuses other than the printing apparatus 100. The medium information stored in the CD/DVD disc 110 by the apparatuses other than the printing apparatus 100 can be read out by the apparatuses other than the printing apparatus 100.

FIG. 7 is a diagram illustrating an example of a label printed on the surface of the CD/DVD disc 110. As shown in FIG. 7, disc information 710, album information 720, capacity information 730, and positioning information 740 are printed on the surface of the CD/DVD disc 110 by the label printing unit 106. The disc information 710 is based on the disc information, described above with reference to FIG. 6, corresponding to the CD/DVD disc 110 and includes the “title information”, the “drafter information”, and the drafting date information.”

The album information 720 is based on the album information, described above with reference to FIG. 6, corresponding to the album stored in the CD/DVD disc 110 and includes the “title information” and the drafting date information.” The capacity information 730 is based on the disc information, described above with reference to FIG. 6, corresponding to the album stored in the CD/DVD disc 110 and is printed in the graph of the use rate with respect to the disc capacity of the CD/DVD disc 110. The positioning information 740 is a mark for matching positions at the time of setting the CD/DVD disc 110 to the label printer 150.

For example, “Disc title: intra-company study group data” is printed as the “title information” of the disc information 710 corresponding to the CD/DVD disc 110, “Date: 2005 Jun. 1” is printed as the “drafting date”, and “Creator: planning department Yoshida” is printed as the “drafter information.” The contents of the CD/DVD disc 110 can be grasped from the disc information 710.

For example, “first time (about study group)” is printed as the “title information” of the album information 720 corresponding to the album 540 having the album ID “Album1” described above with reference to FIG. 5 and “2005 Jun. 1” is printed as the “drafting date information.” For example, “second-time study group (base of development technique)” is printed as the “title information of the album information 720 corresponding to the album 550 having the album ID “Album2” described above with reference to FIG. 5 and “2005 Jun. 15” is printed as the “drafting date information.” The contents of the album stored in the CD/DVD disc 110 can be grasped from the album information 720.

The graph of the use rate “36% (□250 MB□700 MB) of the CD/DVD disc 110 with respect to the disc capacity “700 MB” is printed as the capacity information 730. It can be grasped from the capacity information 730 what size of data can be additionally written to the CD/DVD disc 110.

FIG. 8 is a diagram illustrating an example of a structure of data stored in the CD/DVD disc 110 to which the contents 112 are added. As shown in FIG. 8, this CD/DVD disc 110 is different from the CD/DVD disc 110 described above with reference to FIG. 5, in that an album 560 having an album ID “Album3” is added thereto. Moving picture data 561 are stored in the album 560. The moving picture data 561 are moving picture data in the format of AVI and has a file name of “meeting3.avi.”

FIG. 9 is a diagram illustrating exemplary values of the medium information 111 stored in the CD/DVD disc 110 to which the contents 112 are added. As shown in FIG. 9, a table 900 is different from the table 600 described above with reference to FIG. 6, in that a row 640 is added thereto. The row 640 includes the album information corresponding to the album 560 described above with reference to FIG. 8.

The table 900 is different from the table 600 described above with reference to FIG. 6, in that the label printing statuses 606 of the rows 610 to 630 are updated to “done” by the medium information updating unit 107. Accordingly, the printing status judging unit 104 judges that the disc information corresponding to the CD/DVD disc 110 and the album information corresponding to the album 540 and the album 550 described above with reference to FIG. 5 are already printed on the surface of the CD/DVD disc 110. The printing status judging unit 104 judges that only the album information corresponding to the newly added album 560 is not printed on the surface of the CD/DVD disc 110.

FIG. 10 is a diagram illustrating an example of a label printed on the surface of the CD/DVD disc 110 to which the contents 12 is added. As shown in FIG. 10, the album information 720 corresponding to the album 560 having the album ID “Album3” described above with reference to FIG. 8 is additionally printed on the surface of the surface of the CD/DVD disc 110, in addition to the album information 720 printed on the surface of the CD/DVD disc 110 described above with reference to FIG. 7.

The use rate of the CD/DVD disc 110 to the disc capacity as the capacity information 730 printed on the surface of the CD/DVD disc 110 described above with reference to FIG. 7 is updated from 36% to “64% (≈450 MB÷700 MB).” The added album information 720 and the updated capacity information 730 are based on the disc information corresponding to the album stored in the CD/DVD disc 110 described above with reference to FIG. 9.

In this way, the album information 720 corresponding to the added album can be additionally printed on the surface of the CD/DVD disc 110 so as to be subsequent to the previously printed album information 720, on the basis of the medium information 111 updated by adding the album. The capacity information 730 which is a graph of the use rate of the CD/DVD disc 110 can be additionally printed on the surface of the CD/DVD disc 110 so as to overlap with the previously printed capacity information 730.

FIGS. 11 and 12 are diagrams an example of a method of setting the CD/DVD disc 110 into the label printer 150. As shown in FIGS. 11 and 12, the positioning information 151 is formed on the circumference of the tray, on which the CD/DVD disc 110 is placed, of the label printer 150. As shown in FIG. 12, when a label is printed on the surface of the CD/DVD disc 110, the positioning information 151 are matched with the positioning information 740 printed on the surface of the CD/DVD disc 110 and then the CD/DVD disc 110 is put onto the tray of the label printer 150. Accordingly, the CD/DVD disc 110 can always be set into the label printer 150 along the circumferential direction, thereby always printing a label at a predetermined position.

FIG. 13 is a diagram showing a state that the CD/DVD disc 110 has been finalized and is not rewritable from the state of the CD/DVD disc 110 described above by reference to FIG. 10.

As shown in FIG. 13, a label 1310 indicative of a non-rewritable state by filling the label 730 which has been already printed, and a label 1320 indicative of the non-rewritable state by characters “Can Not Write” are printed on the surface of the CD/DVD disc 110. In this way, the user can easily know whether the CD/DVD disc 110 is rewritable or not.

In this way, according to this embodiment, it is possible to acquire the medium information 111 indicating the contents 112 stored in the CD/DVD disc 110 and to print the label corresponding to the acquired medium information 111 on the surface of the CD/DVD disc 110. Accordingly, the user can easily generate the label including the medium information 111 indicating the contents 112 stored in the CD/DVD disc 110 and print the generated label on the surface of the CD/DVD disc 110. The user can easily grasp what contents 112 are stored in the CD/DVD disc 110 from the label printed on the surface of the CD/DVD disc 110.

According to this embodiment, only the label corresponding to the medium information 111, which is not printed on the surface of the CD/DVD disc 110, among the medium information 111 indicating the contents 112 stored in the CD/DVD disc 110 can be newly printed on the surface of the CD/DVD disc 110. Accordingly, even when the contents 112 is added to the CD/DVD disc 110, it is possible to easily generate the label including the medium information 111 indicating the contents 112 added to the CD/DVD disc 110 and to print the generated label on the surface of the CD/DVD disc 110. The user can easily grasp from the label printed on the surface of the CD/DVD disc 110 what contents 112 are added to the CD/DVD disc 110.

According to this embodiment, only the label corresponding to the medium information 111, which is not printed on the surface of the CD/DVD disc 110, among the medium information 111 indicating the contents 112 stored in the CD/DVD disc 110 can be newly printed at a position, which does not overlap with the label corresponding to the medium information 111 already printed, on the surface of the CD/DVD disc 110. Accordingly, even when the contents 112 is added to the CD/DVD disc 110, it is possible to easily generate the label including the medium information 111 indicating the contents 112 added to the CD/DVD disc 110 and to print the generated label at a position, which does not overlap with the label corresponding to the medium information 111 already printed, on the surface of the CD/DVD disc 110. The user can easily grasp what contents 112 are added to the CD/DVD disc 110, from the label printed at a position, which does not overlap with the label corresponding to the medium information 111 already printed, on the surface of the CD/DVD disc 110.

According to this embodiment, when the label is printed on the surface of the CD/DVD disc 110, it is possible to always set the CD/DVD disc 110 into the label printer 150 along a predetermined circumferential direction thereof by placing the CD/DVD disc 110 on the tray of the label printer 150 so that the positioning information 740 printed on the surface of the CD/DVD disc 110 is matched with the positioning information 151 formed in the label printer 150. Accordingly, even when the contents 112 are added to the CD/DVD disc 110, the label including the medium information 111 indicating the contents 112 added to the CD/DVD disc 110 can be newly printed at a predetermined position on the surface of the CD/DVD disc 110 without unnecessarily overlapping with the previously printed label.

According to this embodiment, it is possible to print the label 730 which is the graph indicative of the disc capacity in the CD/DVD disc 110 calculated by the calculating unit 102 on the surface of the CD/DVD disc 110.

Accordingly, the user can easily print the label 730 indicative of the disc capacity in the CD/DVD disc 110 on the surface of the CD/DVD disc 110. Therefore, the user can understand the disc capacity easily and intuitively by reference to the label 730.

According to this embodiment, it is possible to print the labels 1310 and 1320 indicative of the state whether the CD/DVD disc 110 is rewritable or not.

Accordingly, the user can easily print the label 1310 and the label 1320 indicative of the state whether the CD/DVD disc 110 is rewritable or not on the surface of the CD/DVD disc 110. Therefore, the user can understand whether the CD/DVD disc is rewritable or not.

According to this embodiment, it is possible to acquire the information, indicating the use rate of the CD/DVD disc 110, which is included in the medium information 111 stored in the CD/DVD disc 110 and to print the label corresponding to the information indicating the acquired use rate of the CD/DVD disc 110 on the surface of the CD/DVD disc 110. Accordingly, a user can easily generate the label corresponding to the information indicating the use rate of the CD/DVD disc 110 and print the generated label on the surface of the CD/DVD disc 110. In addition, the user can easily grasp the use rate of the CD/DVD disc 110, such as the amount of disc capacity used, from the label printed on the surface of the CD/DVD disc 110.

Although it has been described in this embodiment that the label is printed directly on the surface of the CD/DVD disc 110 by the label printer 150, the label may be printed on a seal which can be bonded to the surface of the CD/DVD disc 110.

Although it has been described in this embodiment that the CD/DVD disc 110 is used as an example of the recording medium on which the label is printed, the label may be printed on a seal which can be bonded to the surface of the memory card 120 or an FD (Flexible Disc) if it only is a recording medium having portability.

Although it has been described in this embodiment that the capacity information 730 which is a graph of the use rate of the CD/DVD disc 110 is printed on the surface of the CD/DVD disc 110, a numeral indicating the use rate of the CD/DVD disc 110 may be printed on the surface of the CD/DVD disc 110 if only it can indicate the use rate of the CD/DVD disc 110.

Although it has been described in this embodiment that the disc information 710 and the album information 720 are printed on the surface of the CD/DVD disc 110, information indicating the contents 112 such as image data, music data, and moving picture data included in the album may be printed on the surface of the CD/DVD disc 110.

Although it has been described in this embodiment that the CD/DVD disc 110 in which the contents 112 and the medium information are recorded are used by the printing apparatus 100, the CD/DVD disc 110 in which the contents 112 and the medium information are recorded may be used by an apparatus other than the printing apparatus 100. In this way, even when the medium information 111 written to the CD/DVD disc 110 by the apparatus other than the printing apparatus 100 can be read out by the printing apparatus 100, as described above in the embodiment, by constructing the data structure of the CD/DVD disc 110 and the data structure of the medium information 111 in accordance with a standard format determined between a plurality of apparatuses regardless of the types and makers of the apparatuses.

Although it has been described in this embodiment that the medium information 111 along with the contents 112 are acquired from the CD/DVD disc 110, the medium information 111 may be acquired from other recording media such as the HD 305, instead of the CD/DVD disc 110.

In this embodiment, the label including the medium information 111 indicating the contents 112 added to the CD/DVD disc 110 is generated and then the generated label is printed at the position, which does not overlap with the label corresponding to the medium information 111 already printed, on the surface of the CD/DVD disc 110. However, when the label is printed on a seal which can be bonded to the surface of the CD/DVD disc 110, a label including the medium information 111 indicating all the contents 112 stored in the CD/DVD disc 110 may be generated and the generated label may be printed on the seal.

In this embodiment, the disc information 710 and the album information 720 composed of strings are printed on the surface of the CD/DVD disc 110. However, the medium information 111 further including thumbnail images indicating the contents stored in the CD/DVD disc 110 may be acquired and the acquired thumbnail images indicating the contents may be further printed on the surface of the CD/DVD disc 110.

The printing method according to this embodiment can be embodied by causing a printer or a computer such as a personal computer or a work station to execute a predetermined program. In a case where a computer having the disc drive 140 which can read the CD/DVD disc 110 executes the program, the computer includes the medium information acquiring unit 101, the calculating unit 102, the detecting unit 103, the printing status judging unit 104, the label information generating unit 105, and the medium information updating unit 107. A label printer connected to the computer includes the label printing unit 106. On the other hand, in a case where a computer which does not have the disk drive 140 executes the program, a disk drive connected to the computer includes the medium information acquiring unit 101. The computer which uses the medium information acquired form the medium information acquiring unit 101 includes the calculating unit 102, the detecting unit 103, the printing status judging unit 104, the label information generating unit 105, and the medium information updating unit 107. A label printer connected to the computer includes the label printing unit 106. The program is stored in a computer-readable recording medium such as a hard disc, a flexible disc, a CD-ROM, an MO, and a DVD and is read out by the computer from the recording medium for execution. The program may be recorded in a transmission medium which can be distributed through a network such as Internet.

What is claimed is:

1. A printing apparatus comprising:
a medium information acquirer, operable to acquire first medium information indicative of first contents stored in a recording medium;
a label information generator, operable to generate, based on the first medium information, first label information indicative of a first label which is to be printed on the recording medium; and
a printing section, operable to print the first label on the recording medium based on the first label information.

2. The printing apparatus as set forth in claim 1, further comprising:
a judge, operable to judge whether a second label corresponding to second medium information indicative of second contents of the recording medium has been printed on the recording medium, wherein:
the label information generator is operable to generate second label information indicative of the second label in a case where the judge judges that the second label has not been printed on the recording medium.

3. The printing apparatus as set forth in claim 2, wherein:
the printing section is operable to print the second label on the recording medium in a position where the first label is not printed, based on the second label information.

4. The printing apparatus as set forth in claim 2, wherein:
the second medium information includes print status information indicating whether the second label has been printed on the recording medium; and
the judge judges whether the second label is printed on the recording medium based on the print status information.

5. The printing apparatus as set forth in claim 4, further comprising:
an updater, operable to update the print status information.

6. The printing apparatus as set forth in claim 1, wherein:
the printing section is operable to print alignment information on the recording medium in a case where the recording medium is disk-shaped; and
the alignment information is adapted to be referred in order to determine a position on the recording medium to which the first label is printed.

7. The printing apparatus as set forth in claim 1, further comprising:
a calculator, operable to calculate amount information indicative of at least one of an used space amount and a free space amount in the recording medium, wherein:
the label information generator is operable to generate the first label information based on the amount information.

8. The printing apparatus as set forth in claim 1, further comprising:
a judge, operable to judge whether the recording medium is rewritable, wherein:
the label information generator is operable to generate the first label information so as to indicate whether the recording medium is rewritable.

9. The printing apparatus as set forth in claim 8, wherein:
the label information generator is operable to generate the first label information so as to include a character or a symbol indicating that the recording medium is not rewritable.

10. The printing apparatus as set forth in claim 7, wherein:
the label information generator generates the first label information so as to include a graph indicative of the amount information.

11. The printing apparatus as set forth in claim 10, further comprising:
a judge, operable to judge whether the recording medium is rewritable, wherein:
the label information generator is operable to generate the first label information such that the graph indicates that there is no free space in the recording medium in a case where the judge judges that the recording medium is not rewritable irrespective of the amount information.

12. The printing apparatus as set forth in claim 1, wherein:
the medium information is operable to read meta-data stored in the recording medium to acquire the first medium information.

13. A printing method, comprising:
acquiring medium information indicative of contents stored in a recording medium;
generating label information indicative of a label which is to be printed on the recording medium, based on the medium information; and
printing the label on the recording medium based on the label information.

14. A storage medium storing a program causing a computer to execute the method as set forth in claim 13.
